(19) United States
(12) Patent Application Publication
(10) Pub. No.: US 2008/0271323 A1
(43) Pub. Date: Nov. 6, 2008

(54) CUTTING TOOL

(76) Inventor: Thomas Perlmutter, Calabasas, CA (US)

Correspondence Address: MARCIA A. DEVON;DEVON & ASSOCIATES, 400 OCEANGATE BLVD., SUITE 800, LONG BEACH, CA, 90802, US

(21) Appl. No.: 12/113,798

(22) Filed: May 1, 2008

Related U.S. Application Data
(60) Provisional application No. 60/915,356, filed on May 1, 2007.

(51) Int. Cl. B26B 3/06; B26D 1/00

(52) U.S. Cl. 30/162; 83/13

(57) ABSTRACT

A cutting tool includes a housing having a first end with a first edge and a second end. A handle adapted to receive a hand is formed in the housing. The housing encloses a first blade which has a cutting position when the first blade extends from the housing and a retracted position with the blade inside the housing. An elongated finger portion is extended from the first end of the housing. The finger portion and the first edge define an elongated opening having a junction at the first end of the housing. A second blade is embedded in the housing at the preferred angle of 19.5 percent and diagonally spans the opening and the junction. The second is shaped, sized and orientated to facilitate forward slitting of heavy plastic sheet. The first blade slides axially along an interior track. A biasing means repositions the first blade from the retracted position to the cutting position. The first blade makes a slit in the packaging. The elongated finger is then inserted into the opening and the second blade enlarges the slit to the desired length to remove the item from its packaging.

This Application claims the benefit pursuant to 35 U.S.C. 119(e) of U.S. Provisional Patent Application Ser. No. 60/915,356 filed by the applicant on May 1, 2007.

### FIELD OF INVENTION

The present invention relates generally to cutting tools and more particularly to a tool for cutting heavy plastic.

### BACKGROUND OF THE INVENTION

Product packaging has undergone substantial change in recent years and has generally become more difficult to remove. The packaging must withstand the rigors of shipping, impede shop-lifters, and attractively display the product for retail sales and hold the product in a compact container. Increasingly, the packaging material of choice has become plastic. The plastic is formed from heavy clear sheet to conform to the contours of the products and to display the products for the retail sales. The plastic packaging, especially for electronic devices, is very difficult to open safely. The heavy plastic resists cutting, and can become very sharp, cutting the unwary consumer.

There is a clear need for devices which can easily and safely open heavy plastic wrapping. My prior patent, U.S. Pat. No. 7,003,884 B2, provided a tool for opening heavy plastic packaging. However, it was discovered that when my cutting tool was used for cutting the heaviest plastic package repeatedly caused the two main sections of the housing to separate. Further, it was discovered that some injuries were occurring if the tool was used improperly. Therefore, an improved tool is desired which will not separate when subjected to the heaviest use and which is designed to prevent users from being able to injure themselves. My new improved design accomplishes these goals and more.

### BRIEF SUMMARY OF THE INVENTION

The invention incorporates two types of cutting blades encased in a housing and having handle structure for gripping by the user. A means for extending and retracting a first blade is contained within the housing. In the preferred embodiment, the means for extending and retracting the first blade comprises a track, a spring to bias the first blade in its retracted position and a push button to move the position of the blade from the retracted to the extended, cutting position. The spring-biased first blade is extended into its cutting position when the user holds the push button which moves the blade forward. When the first blade is extended using the button, the first blade is then used to cut a small slit into the heavy plastic wrap to begin the opening process.

The end of housing terminates in an extended finger-shaped member and a thumb member separated from each other by an elongated opening. A second blade is placed across the elongated opening at junction of the elongated finger and thumb. The second blade is then urged forward into the slit (made by the first blade) and continues to enlarge the opening until the package is opened.

The angle of the second blade is selected so that the blade will not be in a position to cut the packaging unless the user holds the handle above the packaging. The second cutting blade is placed such that it will cut the packaging only when the handle is held at a 30 degree or greater above the plane of the packaging. The configuration and diagonal placement of the blade at less than 20.5 degrees from the horizontal, and preferably 19.5 degrees, across the opening between the finger and thumb prevents the user from being able to insert his fingers into the slit made in the packaging and subsequently, cut on the plastic.

An interlocking housing assembly is provided to add strength to the construction of the tool. The housing has a front half and a back half, the two halves secured to each other. The inside of the front half of the housing panel is formed with male tabs which are inserted into tab receivers provided on the inside of the back half panel. As the tool is closed, the male tabs are inserted into the tab receivers which lock the front side of the tool to back side of the tool.

### BRIEF DESCRIPTION OF THE DRAWINGS

The invention will be more fully understood by reference to the following drawings that are for illustrative purposes only:

FIG. 1 is a front side view of the present invention;

FIG. 2 is a back side view of the present invention;

FIG. 3 is an interior view (without the second blade) of front side of the present invention.

FIG. 4 is an interior view of back side of the present invention;

FIG. 5 is the front side being inserted the back side of the present invention;

FIG. 6 is another view of the front side being inserted into the back side of the present invention;

FIG. 7 is the illustrates the proper orientation of the present invention when in use;

FIG. 8 illustrates the present invention with the first blade in its cutting position;

FIG. 9 illustrates the first blade mounted to the track on the interior of the housing; and

FIG. 10 illustrates the preferred orientation of the second blade of the cutting tool of the present invention.

### DETAILED DESCRIPTION OF THE PREFERRED EMBODIMENT

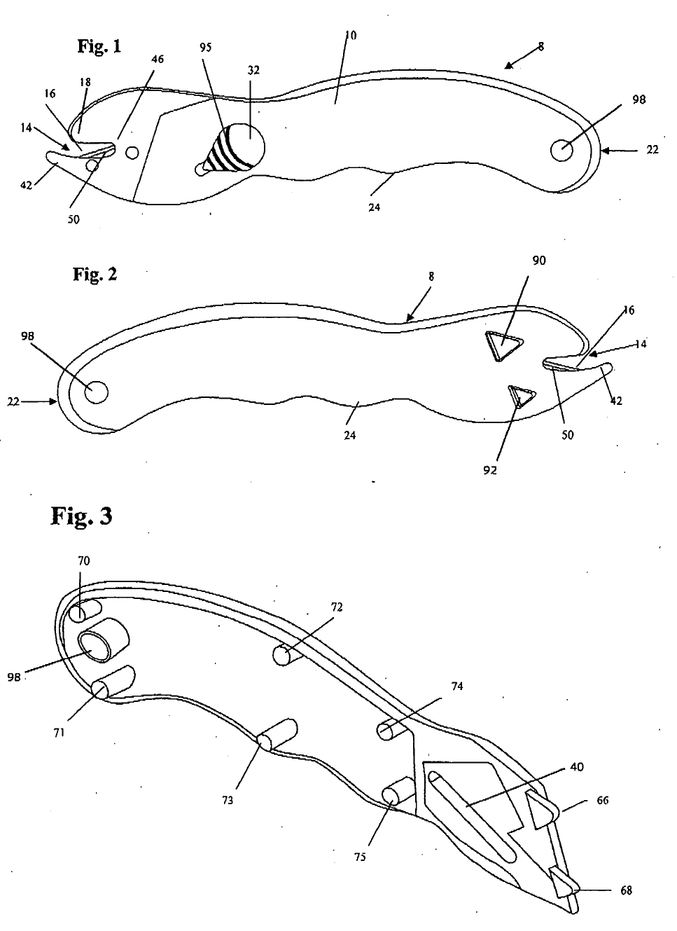

An assembled cutting tool 8 is shown in FIGS. 1 and 8. The cutting tool includes a housing 10 having a first end 14 and a second end 22. The first end 14 is formed with an elongated finger 42 and a thumb 18 separated by an opening 16. The lower portion of the housing 10 is formed with a grip 24 shaped to fit the fingers of the user's hand.

The cutting tool further includes a spring-biased first blade 28 shown in FIGS. 8 and 9. First blade 28 has a cutting position with the blade 28 protruding from the housing 10 as shown in FIG. 8 and a retracted position inside the housing 10 as shown in FIG. 1. In the preferred embodiment, a control mechanism which is preferably, a push button 32 moves the first blade 28 from the retracted position to the cutting position.

The housing forms an elongated finger 42 which extends from the first end 14 of the housing 10 forming a cantilever. The finger 42 is located opposite to the thumb 18 and is formed at the termination of the first end 14 of the housing. The finger 42 and the thumb 18 define an elongated opening 16 and form a junction 46 at the first end 14 of the housing 10. The length of the finger is selected so that it may readily navigate through the packaging.

A second blade 50 is molded into the housing 10 and mounted across the opening 16 at the junction 46 of the finger 42 and the thumb 18. The cutting blade 50 is shaped, sized and orientated to facilitate forward cutting of heavy plastic and other types of packaging.

To use the tool, the operator first pierces the packaging with the first blade 46 in its extended cutting position. The finger 42 is then inserted into the opening formed by the first blade and urged forward cutting the packaging as desired to remove the product inside the packaging.

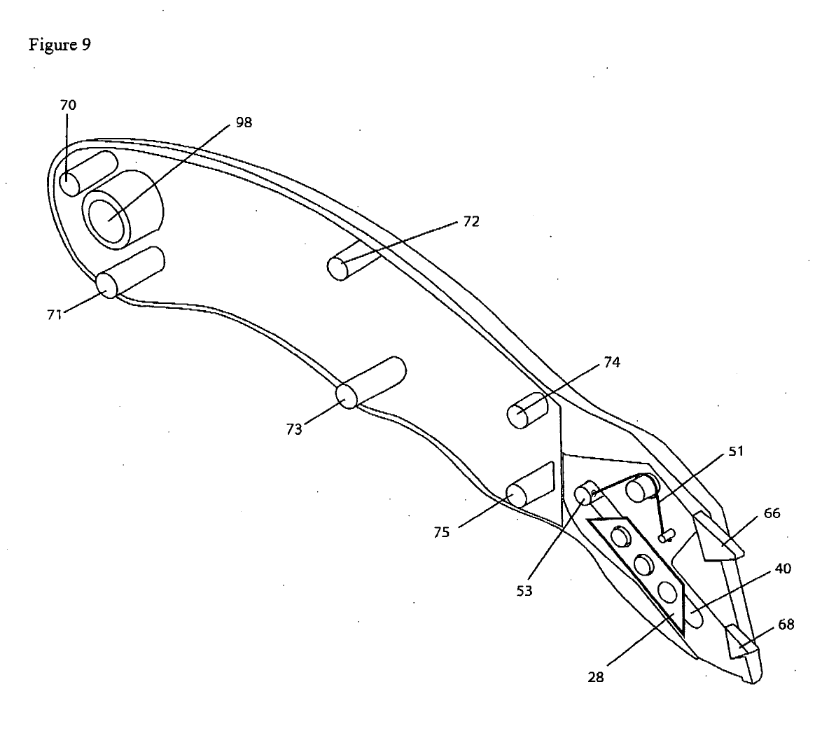

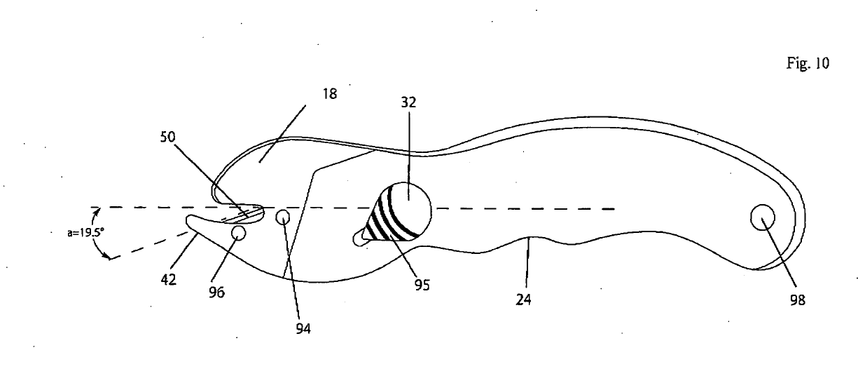

The second blade 50 is oriented across the junction 46 at an angle selected to prevent the user from being able to cut the packaging unless the second end of the tool is at an angle of 30 degrees from the packaging as shown in FIG. 7. The angle a formed by the second blade 50 from an axis formed on a line bisecting the tool is 19.5 degrees in the preferred embodiment as shown in FIG. 10. When the angle a is less than 20.5 degrees, the user will be unable to cut himself by placing his fingers into the plastic when the user is operating the cutting tool.

The first end 14 is formed with two indentations 94 and 96 which receive magnets (not shown) in the production mold. The magnets hold the second blade 50 in the desired location when the second blade 50 is molded in place in the housing. After the plastic forming the housing cures, the magnets slide out.

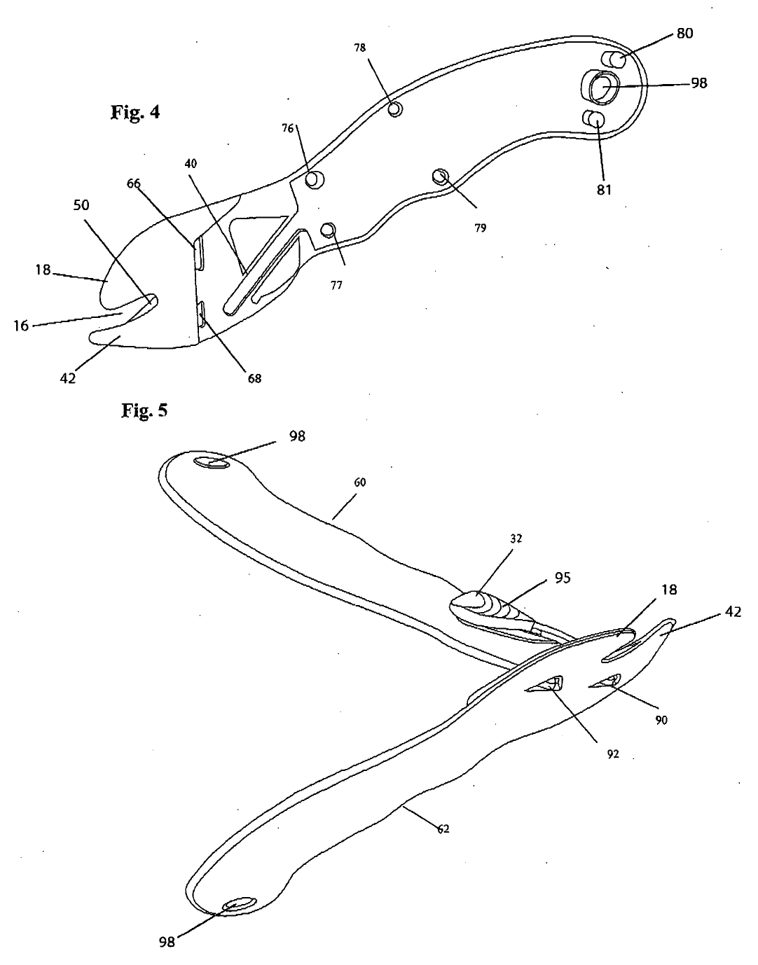

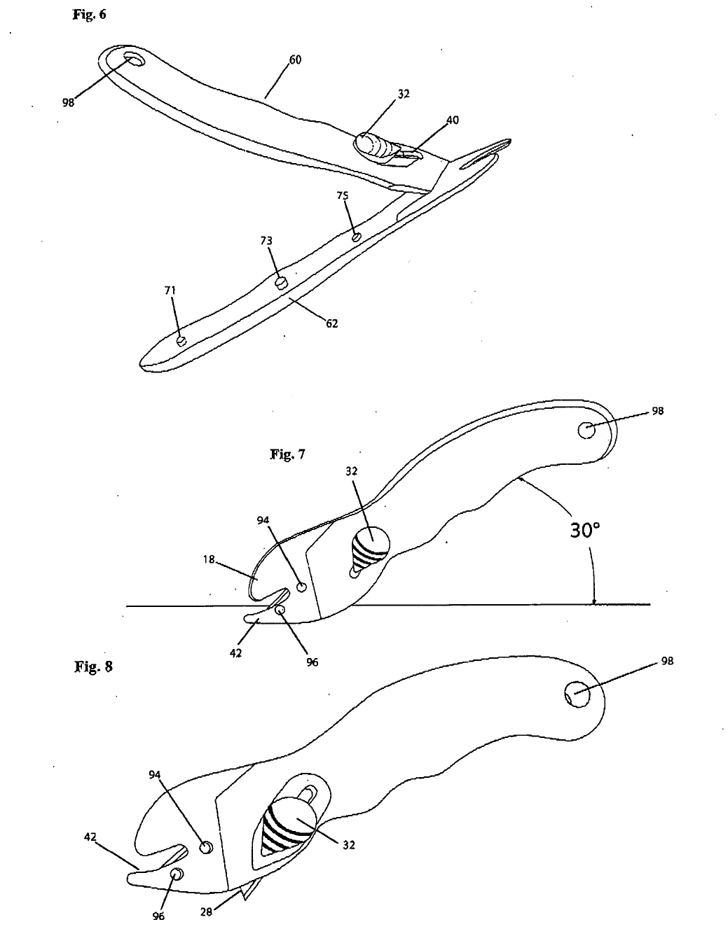

It will be appreciated that there are a number of ways in which the first blade 28 can be moved from its retracted to its extended cutting position, with various control mechanisms. In the preferred embodiment, the first blade 28 is mounted on a track 40 as shown in FIG. 4 and FIG. 9 and has a spring-biasing means 51. The first blade 28 slides axially along the track in response to the movement of the shaft 53 on the reverse side of the push button 32. The spring biasing means 51 repositions the first blade 28 from the cutting position shown in FIG. 8 to the retracted position shown in FIG. 1. In yet another preferred embodiment, the push button 34 includes ridges or grip lines 95 to provide traction.

The housing 10 is preferably formed as two substantially flat layers 60 and 62 (both are shown in FIG. 5). The two layers 60 and 62 are affixed to each other and secured with pegs 70-75 illustrated in FIG. 3. The pegs are received by apertures 76-80. The two layers 60 and 62 further are interlocked to each other utilizing male tabs 66 and 68 which are shown in FIG. 3. The inside of the front housing panel is formed with male tabs 66 and 68 which are inserted into slots 90 and 92 provided on the inside of the back panel. As the tool is closed, the male tabs are inserted into the slots 90 and 92 which affix the front side of the tool to back side of the tool. The two layers 60 and 62 are then preferably sonically welded together. The housing is thus assembled securely so that it will not separate despite repeated and substantial use. An opening 98 is formed on the second end 22 of the housing so that the tool can be stored on a hook if desired by the user.

The length “y” of the finger 42 has been determined to be optimized at one and five-eighth inches extending from the edge of the blade as shown in FIG. 7, so as to best navigate through packaging. The width of the finger at its outer end is preferably three sixteenth inches. The first blade 29 preferably extends ¼ inch from the tool housing when it is in its extended position.

The present disclosure includes that contained in the present claims as well as that of the foregoing description. Although this invention has been described in its preferred forms with a certain degree of particularity, it is understood that the present disclosure of the preferred forms has been made only by way of example and numerous changes in the details of construction and combination and arrangement of parts may be resorted to without departing from the spirit and scope of the invention. Accordingly, the scope of the invention should be determined not only by the embodiments illustrated, but by the appended claims and their legal equivalents.

What is claimed is:

1. A cutting tool comprising:
a housing, said housing having a first end and a second end, said first end having a thumb, said housing further having a first panel and a second panel wherein tabs are formed on said first panel, slots are formed on said second panel, said slots receiving and securing said tabs;
a track formed in said first panel;
a handle extending from the second end of said housing;
a first blade, sliding on said track in said housing, said first blade having a retracted position within said housing and a cutting position in which said first blade slides on said track and extends past the first end of the housing;
a control mechanism for moving said first blade from said retracted position to said cutting position;
a finger portion projecting from said first end of said housing, said finger portion located opposite said thumb of said first end, said finger portion and said thumb defining an elongated opening and;
a second blade spanning said elongated opening, said second blade being adapted to facilitate forward slitting.

2. A cutting tool according to claim 1 wherein said control mechanism comprises a push button, a biasing means which maintains said first blade in said retracted position and said push button urges said first blade into said extended position.

3. The cutting tool of claim 1 wherein said second blade is embedded in said housing diagonally across said elongated opening at an angle of less than 20.5 degrees from a horizontal axis bisecting said tool.

4. The cutting tool of claim 1 wherein said second blade is diagonally placed across said elongated opening at an angle of 19.5 degrees from a horizontal axis bisecting said tool.

5. The cutting tool of claim 1 wherein said elongated finger extends one and five-eighths from the end of said housing.

6. The method of cutting plastic packaging, with a cutting tool having a first and second blade, a grip, and a finger, said method comprising the steps of:
extending a first blade;
piercing the packaging making a slit with said first blade;
retracting said first blade;
positioning said finger in said slit in said packaging such that the second blade contacts said packaging; and
pressing said second blade forward into said slit such that the second blade abuts said slit and enlarging the slit to remove the packaging while holding the grip at an angle of 30 degrees above the packaging.

7. The method of claim 7 wherein said second blade is pressed forward into said slit at an angle of 19.5 degrees from a horizontal axis bisecting the tool.

8. The cutting tool of claim 1 wherein an opening is formed in said second end of said housing.

9. The cutting tool of claim 1 further including pegs formed in said first panel received by apertures in said second panel.
